(19) United States
(12) Patent Application Publication
(10) Pub. No.: US 2024/0354515 A1
(43) Pub. Date: Oct. 24, 2024

(54) SYSTEMS AND METHODS FOR ACTION SUGGESTIONS

(71) Applicant: YAHOO ASSETS LLC, New York, NY (US)

(72) Inventors: Bassem BOUGUERRA, Long Beach, CA (US); Kevin PATEL, Fremont, CA (US); Shashank KHANNA, Fremont, CA (US); Shiv Shankar SAHADEVAN, San Jose, CA (US)

(21) Appl. No.: 18/476,380

(22) Filed: Sep. 28, 2023

Related U.S. Application Data
(60) Provisional application No. 63/497,944, filed on Apr. 24, 2023.

(51) Int. Cl. G06F 40/40; H04L 51/02; H04L 51/216

(52) U.S. Cl. CPC G06F 40/40; H04L 51/02; H04L 51/216

(57) ABSTRACT

In some implementations, the techniques described herein relate to a method including: (i) identifying, by a processor, a plurality of electronic messages addressed to a user, (ii) analyzing, by a large language model executed by the processor, the plurality of electronic messages to identify potential actions, (iii) suggesting, by the processor, to the user, a potential action identified by the large language model, (iv) receiving, by the processor, user input related to the potential action, and (v) performing, by the processor, on behalf of the user, a subsequent action conforming to the user input.

### CROSS-REFERENCE TO RELATED APPLICATIONS

This application claims the benefit of Provisional Patent Application No. 63/497,944, filed on Apr. 24, 2023, which is hereby incorporated by reference in its entirety.

### BACKGROUND

A user typically receives hundreds of messages a day, many of which contain useful information about scheduling, appointments, action items, or events that are important to the user. An account inbox of a user, if not tended to frequently throughout the day can become full and have several pages of messages. Often the user does not have time to search back through several pages of emails to determine which messages require action. The sheer number of messages a user receives on a daily basis makes it difficult to determine and follow-up on messages of high importance, especially when there are pages upon pages of messages to sift through. For example, a user may have received a message from a dentist to call to book an appointment, but the user overlooked the message, and the user is no longer searching through past messages. The user may miss the appointment message completely and fail to follow-up on important items. Accordingly, this disclosure suggests improved systems and methods for performing action suggestions.

### BRIEF DESCRIPTION OF THE DRAWINGS

FIG. 1 is a block diagram illustrating a system for performing action suggestions according to some of the example embodiments.

FIG. 2 is a flow diagram illustrating a method for performing action suggestions according to some of the example embodiments.

FIG. 3 is an illustration of an example of action suggestions according to some of the example embodiments.

FIG. 4 is a flow diagram illustrating a method of action suggestions according to some of the example embodiments.

FIG. 5 is a block diagram of a computing device according to some embodiments of the disclosure.

### DETAILED DESCRIPTION

Various machine learning (ML) and artificial intelligence (AI) models are capable of analyzing and/or generating text. One example of such a model is a large language model (LLM). An LLM is a statistical model that predicts the next word in a sequence, given the previous words (often referred to as a “prompt”). LLMs are trained on massive datasets of text, and can be used for a variety of tasks, such as text generation, translation, and question answering. LLMs are typically composed of a neural network with many parameters (typically billions of weights or more). The neural network is trained on a large dataset of text and learns to predict the next word in a sequence, given the previous words. While LLMs are used primarily in the following description, the embodiments described herein can apply equally to other types of text generation models including, but not limited to, long short-term memory (LSTM) models, recurrent neural networks (RNNs), encoder-decoder models, transformer-based models, specialized convolutional neural networks (CNNs) and the like.

The example embodiments herein describe methods, computer-readable media, devices, and systems that provide the contents of an email inbox or other message inbox as input to an LLM and output one or more suggested actions. In some examples, a user may agree to a suggested action and the LLM may carry out the action. For example, an LLM may send a follow-up email, create a calendar event, and so forth.

In some implementations, the techniques described herein relate to a method including: (i) identifying, by a processor, a plurality of electronic messages addressed to a user, (ii) analyzing, by a large language model executed by the processor, the plurality of electronic messages to identify potential actions, (iii) suggesting, by the processor, to the user, a potential action identified by the large language model, (iv) receiving, by the processor, user input related to the potential action, and (v) performing, by the processor, on behalf of the user, a subsequent action conforming to the user input.

In some implementations, the techniques described herein relate to a method, wherein performing the subsequent action comprises performing the subsequent action via a large language model agent that interoperates with the large language model.

In some implementations, the techniques described herein relate to a method, wherein identifying the plurality of electronic messages comprises identifying a thread of messages about the same subject and analyzing messages within the thread in context with other messages within the thread.

In some implementations, the techniques described herein relate to a method, receiving user input related to the potential action comprises receiving a modification of the potential action provided by the user via a chat interface and generating a new potential action using the large language model, wherein performing the subsequent action comprises performing the new potential action.

In some implementations, the techniques described herein relate to a method, wherein performing the subsequent action comprises creating a digital calendar event on behalf of the user.

In some implementations, the techniques described herein relate to a method, wherein performing the subsequent action comprises sending an additional electronic message on behalf of the user.

In some implementations, the techniques described herein relate to a method, wherein performing the subsequent action comprises sending input to an application programming interface.

In some implementations, the techniques described herein relate to a method, wherein suggesting the potential action to the user comprises generating, by the large language model, a description of the potential action and displaying the description in a user interface.

In some implementations, the techniques described herein relate to a non-transitory computer-readable storage medium for tangibly storing computer program instructions capable of being executed by a computer processor, the computer program instructions defining steps of: (i) identifying, by a processor, a plurality of electronic messages addressed to a user, (ii) analyzing, by a large language model executed by the processor, the plurality of electronic messages to identify potential actions, (iii) suggesting, by the processor, to the user, a potential action identified by the large language model, (iv) receiving, by the processor, user input related to the potential action, and (v) performing, by the processor, on behalf of the user, a subsequent action conforming to the user input.

In some implementations, the techniques described herein relate to a non-transitory computer-readable storage medium, wherein performing the subsequent action comprises performing the subsequent action via a large language model agent that interoperates with the large language model.

In some implementations, the techniques described herein relate to a non-transitory computer-readable storage medium, wherein identifying the plurality of electronic messages comprises identifying a thread of messages about the same subject and analyzing messages within the thread in context with other messages within the thread.

In some implementations, the techniques described herein relate to a non-transitory computer-readable storage medium, receiving user input related to the potential action comprises receiving a modification of the potential action provided by the user via a chat interface and generating a new potential action using the large language model, wherein performing the subsequent action comprises performing the new potential action.

In some implementations, the techniques described herein relate to a non-transitory computer-readable storage medium, wherein performing the subsequent action comprises creating a digital calendar event on behalf of the user.

In some implementations, the techniques described herein relate to a non-transitory computer-readable storage medium, wherein performing the subsequent action comprises sending an additional electronic message on behalf of the user.

In some implementations, the techniques described herein relate to a non-transitory computer-readable storage medium, wherein performing the subsequent action comprises sending input to an application programming interface.

In some implementations, the techniques described herein relate to a non-transitory computer-readable storage medium, wherein suggesting the potential action to the user comprises generating, by the large language model, a description of the potential action and displaying the description in a user interface.

In some implementations, the techniques described herein relate to a device including: a processor; and a storage medium for tangibly storing thereon logic for execution by the processor, the logic including instructions for: (i) identifying, by the processor, a plurality of electronic messages addressed to a user, (ii) analyzing, by a large language model executed by the processor, the plurality of electronic messages to identify potential actions, (iii) suggesting, by the processor, to the user, a potential action identified by the large language model, (iv) receiving, by the processor, user input related to the potential action, and (v) performing, by the processor, on behalf of the user, a subsequent action conforming to the user input.

In some implementations, the techniques described herein relate to a device, wherein performing the subsequent action comprises performing the subsequent action via a large language model agent that interoperates with the large language model.

In some implementations, the techniques described herein relate to a device, wherein identifying the plurality of electronic messages comprises identifying a thread of messages about the same subject and analyzing messages within the thread in context with other messages within the thread.

In some implementations, the techniques described herein relate to a device, receiving user input related to the potential action comprises receiving a modification of the potential action provided by the user via a chat interface and generating a new potential action using the large language model, wherein performing the subsequent action comprises performing the new potential action.

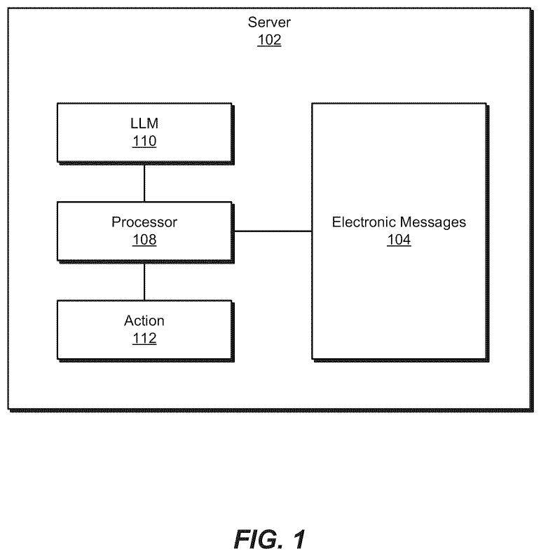

FIG. 1 is a block diagram illustrating a system for performing action suggestions according to some of the example embodiments.

The illustrated system includes a server 102. Server 102 may include a processor 108 that can identify electronic messages 104 received by a user. In some implementations, server 102 may be configured with or otherwise be in communication with an LLM 110 that analyzes electronic messages 104 to identify potential actions. In one implementation, one or more systems on server 102 may suggest potential action 112 to the user and receive user input related to action 112. In response, processor 108 may (via various agents, including in some examples LLM 110) perform action 112 and/or a subsequent action on behalf of the user. Although illustrated here on server 102, any or all of the systems described herein may be hosted by one or more client devices, servers, and/or cloud-based processing resources. Further details of these components are described herein and in the following flow diagrams.

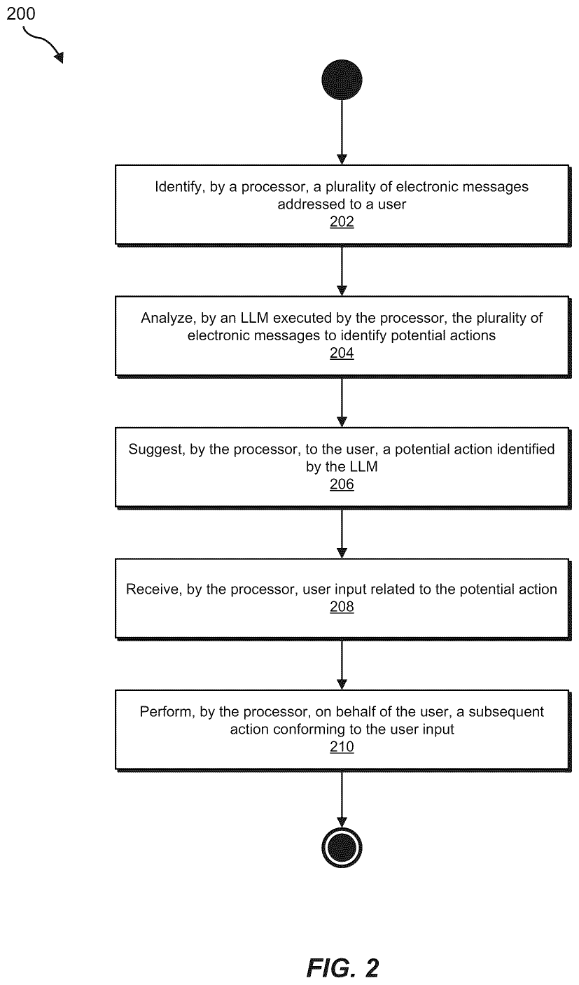

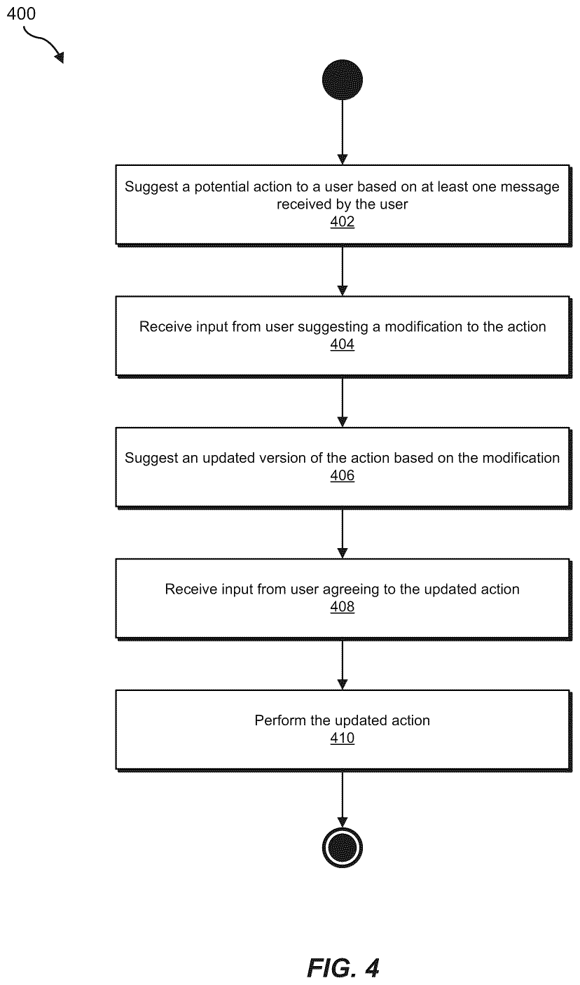

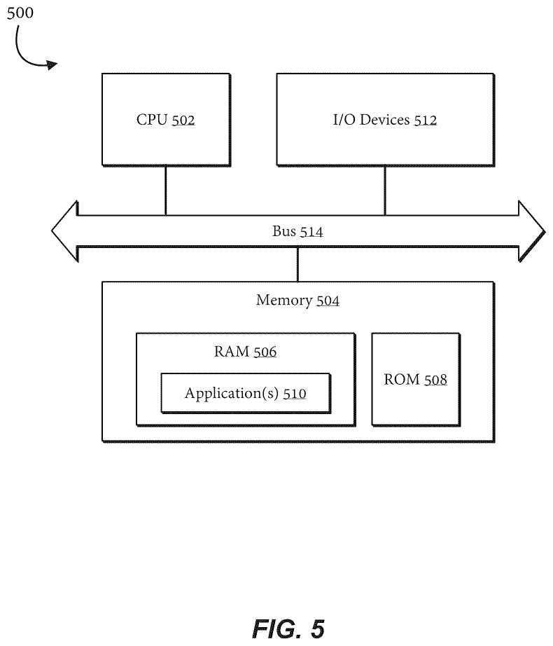

In the various implementations, server 102, processor 108, and LLM 110 can be implemented using various types of computing devices such as laptop/desktop devices, mobile devices, server computing devices, etc. Specific details of the components of such computer devices are provided in the description of FIG. 5 which are not repeated herein. In general, these devices can include a processor and a storage medium for tangibly storing thereon logic for execution by the processor. In some implementations, the logic can be stored on a non-transitory computer readable storage medium for tangibly storing computer program instructions. In some implementations, these instructions can implement some of all of the methods described in FIG. 2 and FIG. 4.

In some implementations, electronic messages 104 can comprise any digital messages that includes text or an audio or video file from which words can be extracted as text, such as a voicemail or video message. Examples of electronic messages 104 may include, without limitation, email, instant messages, voicemail, video message, and/or short messaging service messages.

In some implementations, action 112 may comprise any type of action that can be performed by a digital agent and/or process. In some examples, action 112 may include an action performed by a digital agent on behalf of a user to complete a task related to one or more electronic messages. For example, action 112 may include sending a request to an application programming interface (API). In one example, action 112 may include composing, sending, and/or categorizing (e.g., by creating and/or managing a folder) one or more electronic messages. In some examples, action 112 may include scheduling a calendar event in a digital calendar.

FIG. 2 is a flow diagram illustrating a method 200 for performing action suggestions according to some of the example embodiments.

In step 202, the method can include identifying, by a processor, a plurality of electronic messages addressed to a user.

In some implementations, the method may identify a plurality of electronic messages in a digital inbox, such as an email inbox. Additionally, or alternatively, the method may identify a plurality of electronic messages across various folders including an inbox, an archive, subject-matter folders, etc. In some examples, the electronic messages may have been received by the user (e.g., viewed and/or opened by the user). In other examples, the electronic messages may have been received by the user's account but not viewed or opened by the user yet. In some examples, the electronic messages may be addressed to a group and/or a mailing list that includes the user rather than addressed to the user individually.

In one implementation, the processor may be hosted on a server and may identify a plurality of electronic messages stored on one or more servers (e.g., stored on a message server, stored in cloud storage, etc.). Alternatively, the processor may be hosted on a client device and the method may identify a plurality of messages loaded by the client device. In some implementations, the plurality of electronic messages can include only electronic messages received by the user. In other implementations, the plurality of electronic messages can include both electronic messages sent and received by the user.

In some examples, the method may identify the plurality of messages in response to receiving a request from a user. For example, a user may input a command into a chat interface that prompts the method to identify the plurality of messages in order to carry out the command. In one example, the user may input the command, “find messages from Gary about the home reno” and the method may identify the plurality of messages in order to search for messages from Gary with keywords relating to remodeling, construction, and/or renovation. In some implementations, the method can include converting the command into an embedding and searching an embedding space of the plurality of messages to find semantically relevant messages.

Additionally, or alternatively, the method may identify the plurality of messages as part of a scheduled routine. For example, the method may execute on a server every minute, every hour, every time a message is received, once a day, etc., and may identify and analyze any new messages received since the last analysis. In some implementations, the method can use a time window to identify batches of messages to analyze. In one implementation, the method may identify and re-analyze previously received messages with the context of the new messages. For example, if a user receives a message about a trip to Paris, the method may identify and re-analyze previously received messages to discover if the user has previously received additional messages about the trip to Paris that provide additional context that enable the method to suggest a potential action related to the trip to Paris. In one example, the method may identify a newly received message suggesting hotels in Paris and may then identify a previously received message suggesting flights to Paris during specified dates that may enable the method to determine the dates for which to suggest booking the suggested hotels.

In step 204, the method can include analyzing, by an LLM executed by the processor, the plurality of electronic messages to identify potential actions.

In some implementations, the LLM may parse the content and/or metadata (e.g., sender, date, subject, etc.) of the electronic messages to determine whether the content and/or metadata indicates a potential action. For example, an email thanking a friend for a gift may not indicate a potential action while an email being invited by a friend to lunch may indicate a potential action of making a lunch reservation at a restaurant and/or adding a lunch event to a calendar.

In some implementations, the LLM may analyze data from multiple messages in conjunction in order to identify potential actions related to more than one message. For example, the LLM may analyze multiple messages in a message chain (e.g., from one or more senders), multiple messages from the same sender, multiple messages stored in the same folder, etc., in conjunction. As discussed, the specific amount of messages analyzed is not limiting and, for example, the method can include analyzing a user's entire message corpus (although subsets thereof are also within the scope of the disclosure).

In one example, the LLM may analyze the messages in an email chain about planning a vacation to identify potential actions related to booking travel arrangements for the vacation. For example, the method may analyze a first message about a trip to Paris proposing several sets of dates, a second message about the trip to Paris suggesting specific hotel flights on one set of dates proposed in the previous message, and a third message about the trip to Paris suggesting a hotel. In this example, the method may identify a potential action of booking a hotel for the trip to Paris and may, based on the combined contents of the message chain, suggest booking the suggested hotel for the set of dates that match the flights. In one implementation, the method may prepare an API request to the hotel website to book the hotel.

In some implementations, the method can include using one or more LLM agents to identify potential actions. In brief, an LLM agent comprises a plugin or similar component that performs specific tasks that can be triggered based on the processing of the LLM. The LLM provides the LLM agent with necessary date to operate and returns a specific result. Continuing the foregoing example, a “hotel agent” may receive the name of a hotel and identify a corresponding API (or return a null result if no such API exists). In this manner, an LLM can be extended to arbitrary tasks (e.g., web searching, getting data from a user's calendar, etc.) that are not part of the initial training or re-training of the LLM.

The LLM may predict one or more potential actions for the user in a variety of ways. For example, the LLM may parse the content and/or metadata of the electronic message for keywords or phrases that indicate types of actions. In one example, the LLM may scan for dates, locations, and so forth. In some implementations, the LLM may suggest potential actions based on the date that a message was received. For example, if the method identifies a message about confirming a dentist appointment that was received on today's date, the method may not suggest a potential action. However, if the method identifies a message about confirming a dentist appointment that was received several days prior to today's date, the method may suggest a potential action of confirming the appointment.

In some implementations, the LLM may identify messages sent by the user in response to the message(s) being analyzed. For example, if the user has received a message inviting the user to lunch and the user has responded to decline the invitation, the method may determine that no potential action is associated with the received message. By contrast, if the user has not yet responded, the method may identify a potential action of responding to the message.

In some implementations, the LLM may parse text from the message. Additionally, or alternatively, the LLM may process other types of content. For example, an image parser may parse an image into text that the LLM receives as input. Similarly, a video parser may parse a video into text (e.g., captioning, descriptive text, etc.) that the LLM receives as input. In one example, the method may identify an attachment to the message and may provide information about the attachment (e.g., file name, file type, contents, etc.) as input to the LLM. For example, the method may identify an attachment that is a graphic of a birthday party invitation and may predict a potential action of purchasing a birthday gift. As another example, the method can analyze audio (e.g., voice commands or dictation audio) and convert this audio to text before inputting the audio into an LLM.

In some embodiments, the method may prepare a prompt for the LLM and may provide the prompt as input alongside the message, as illustrated in the following example.

Example email: It was nice seeing you yesterday, too! Lunch tomorrow sounds great. We can try that Indian fusion place on 3^{rd} street, Curry And More. I've heard they have really good butter chicken. I'm free at 1 pm if that works for you.

Example prompt: Analyze this email for a potential action being discussed in the email. Look for dates or verbs that indicate future plans. Make note of any names, numerical amounts, or uniform resource locators. Output at least one suggested action based on the contents of this message. Use concise natural language and phrase the suggestion as a question.

Example output: Do you want to send an email accepting the invitation and make a reservation at Curry And More for 1 pm tomorrow?

In some implementations, the LLM may be trained on a corpus of training data that includes electronic messages and subsequent actions. Additionally, or alternatively, the LLM may use the user's electronic messages and actions as training data in order to continue adapting to the user's specific needs and preferences. For example, if the user typically pays bills only after receiving two reminder emails, the LLM may only suggest an action of paying a bill after detecting two emails related to the bill have been received by the user within the last month.

In step 206, the method can include suggesting, by the processor, the potential action to the user.

In some implementations, processor may suggest the potential action by prompting the LLM to generate a summary of the potential action and presenting the summary to the user via a user interface (UI).

Example action: Use the application programming interface of the Curry and More restaurant's website to send a reservation request for two people for an outdoor table for 1 pm on May 16^{th}. Upon receipt of confirmation of the reservation, create a calendar event for 1 pm on May 16^{th} at the location of the Curry and More restaurant and add George to the calendar event via the email address included in the “to” section of the current email.

Example summary: Would you like to make a reservation at Curry and More for tomorrow at 1 μm and invite George to a calendar event for lunch?

The method may use a variety of UI elements. For example, the method may display a pop-up notification asking the user if they would like the potential action performed on their behalf. In another example, the method may prepare the potential action, such as drafting an email, generating additional text for an email, or creating a calendar event, display the prepared action to the user, and ask the user to approve the action. In one example, the method may draft a message, create the message, and then display the message with a UI element that prompts the user to accept or reject sending the message.

In step 208, the method can include receiving, by the processor, user input related to the potential action.

In some examples, the user input related to the potential action may indicate the user's agreement to the potential action. In some implementations, the method may receive the user input via a user's interaction with a UI element. For example, a user may click on an “accept” or “approve” button. In another example, a user may send a message drafted by the LLM. In some examples, the user may communicate approval of the action and/or suggested edits to the action to the LLM via text. For example, the LLM may receive the input “send the email Thursday instead” (e.g., via a chat dialog or similar UI element) and may schedule the drafted email to be sent on the next Thursday rather than immediately.

In some implementations, the method can include presenting a chat dialog in addition to the suggested actions. In this manner, the user can provide further instructions to the LLM on what actions to take or how to modify the actions as discussed in more detail in FIG. 4.

In step 210, the method can include performing, by the processor, on behalf of the user, a subsequent action conforming to the user input.

In response to the LLM output and/or user input, the method may perform a variety of actions. For example, the method may create one or more messages, send an API request, initiate a purchase, and/or create a calendar reminder. In some examples, the method may suggest and then perform multiple potential actions. For example, if the method detects a series of messages with a contractor about home renovations, the method may create a calendar event for a meeting with the contractor, send an email to the contractor inviting them to the meeting, move all messages related to home renovations to a dedicated folder, and create a reminder to get quotes from additional contractors for related work.

In some implementations, the method may interface with other systems to perform actions. For example, the method may create formatted output that can be used as input to an API for another application such as a calendar application, reservation application, store application, etc., in order to perform an action. In some implementations, the LLM may be trained or pre-loaded with the correct formatting for communicating with various relevant APIs. Additionally, or alternatively, the method may include passing LLM output to a parser that formats the output appropriately for providing as API input. In some implementations, the processor may perform the potential action based on the output of the LLM. In other implementations, the LLM can be configured to perform the action itself (e.g., via one or more autonomous agents).

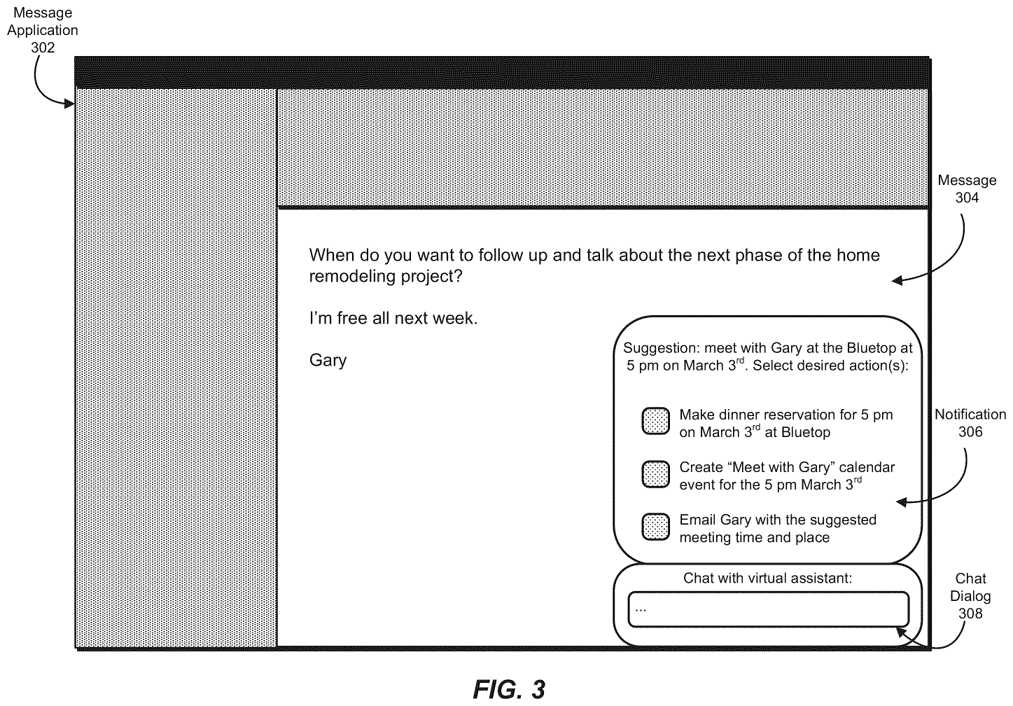

FIG. 3 is an illustration of an example of message automation according to some of the example embodiments.

As illustrated in FIG. 3, in one implementation, the systems described herein may detect a message 304 received by a user is currently open in a messaging application 302. In some implementations, the method may analyze messages received by a user and stored on a server and may deliver recommendations once the method detects that a message for which a recommended potential action exists is open in messaging application 302. Additionally, or alternatively, the method may notify the user of potential actions as soon as the method detects the user interacting with application 302 regardless of which (if any) message is currently open. In some implementations, the method may notify the user of potential actions via other means, such as notification pop-ups.

In response to detecting that message 304 and/or messaging application 302 open, the method may display a notification 306 that includes one or more potential actions related to message 304. For example, the method may analyze message 304 (e.g., in response to message 304 and/or application 302 being opened or beforehand) and determine that message 304 is related to a home remodeling project. In response, the method may suggest a potential action related to meeting with the contractor at a specified place and time and may display notification 306 that lists these potential actions.

In some implementations, the UI may include a chat dialog 308 that enables the user to input text commands to the LLM and/or an agent operated by the processor that parses the text commands into prompts for the LLM. For example, the user may enter a command “move all remodeling emails to a folder” and, in response, the method may create a folder named “home remodel” and move all relevant emails to the new folder.

In one example, the user may check one or more boxes on notification 306 to indicate agreement to one or more of the suggested potential actions. For example, the user may check the box to create a calendar event. In this example, the systems described herein may then create a calendar event for the user using the information from message 304.

FIG. 4 is a flow diagram illustrating a method 400 for performing action suggestions according to some of the example embodiments.

In step 402, the method can include suggesting a potential action to a user based on at least one message received by the user.

In one example, the method may include determining, by an LLM, that a message received by the user is from an auto mechanic and includes a quote for an oil change and that the user has not yet responded to this message. In this example, the method may suggest responding to the message from the auto mechanic with a message that includes scheduling the oil change and requesting a quote for car detailing. Further details on suggesting potential actions using an LLM are provided in the description of FIG. 3 and not repeated herein.

In step 404, the method can include receiving input from the user suggesting a modification to the action.

For example, the user may input text to the LLM via a chat function such as, “no detailing quote but ask about a brake inspection.” In another example, the user may manually edit the text suggested by the LLM. For example, the user may remove the text about requesting a quote for detailing.

In step 406, the method can include suggesting an updated version of the action based on the modification.

In some implementations, the LLM may modify the original action based on the modification suggested by the user. For example, the LLM may remove the text about getting a quote for detailing and add new text about getting a quote for a brake inspection.

In some embodiments, the method may compose a prompt to provide to the LLM as input in order to generate the updated version of the action.

Example suggested action: Send an email to the auto mechanic with the following text: “That quote sounds good. I'd like to bring my car in next Friday between 10 am and 3 pm if possible. I would also like a quote for detailing the car.”

Example user modification: No detailing quote. Ask about brake inspection and combo deals.

Example prompt: Modify the above email by removing the sentence asking about detailing the car. Add a sentence asking about a brake inspection. Add a sentence asking for a combo deal. Match the tone of the original email.

Example output: Send an email to the auto mechanic with the following text: “That quote sounds good. I'd like to bring my car in next Friday between 10 am and 3 pm if possible. I would also like a quote for inspecting both the front and the rear brakes. Would it be possible to get a combo deal since I am requesting two services?”

In step 408, the method can include receiving input from the user agreeing to the updated action.

In one implementation, the LLM may receive input from the user via a UI element such as a button. For example, the user may send the updated message. In another example, the user may click or tap an “agree” button on a notification about the action.

In step 410, the method can include performing the updated action.

For example, the LLM may send the updated message instead of the originally suggested message. In one example, the LLM may send the message with the text about a quote on a brake inspection rather than the message with text about a quote for car detailing.

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 5, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
identifying, by a processor, a plurality of electronic messages addressed to a user;
analyzing, by a large language model executed by the processor, the plurality of electronic messages to identify potential actions;
suggesting, by the processor, to the user, a potential action identified by the large language model;
receiving, by the processor, user input related to the potential action; and
performing, by the processor, on behalf of the user, a subsequent action conforming to the user input.

2. The method of claim 1, wherein performing the subsequent action comprises performing the subsequent action via a large language model agent that interoperates with the large language model.

3. The method of claim 1, wherein identifying the plurality of electronic messages comprises identifying a thread of messages about a same subject and analyzing messages within the thread in context with other messages within the thread.

4. The method of claim 1, wherein receiving user input related to the potential action comprises receiving a modification of the potential action provided by the user via a chat interface and generating a new potential action using the large language model, wherein performing the subsequent action comprises performing the new potential action.

5. The method of claim 1, wherein performing the subsequent action comprises creating a digital calendar event on behalf of the user.

6. The method of claim 1, wherein performing the subsequent action comprises sending an electronic message on behalf of the user.

7. The method of claim 1, wherein performing the subsequent action comprises sending input to an application programming interface.

8. The method of claim 1, wherein suggesting the potential action to the user comprises generating, by the large language model, a description of the potential action and displaying the description in a user interface.

9. A non-transitory computer-readable storage medium for tangibly storing computer program instructions capable of being executed by a computer processor, the computer program instructions defining steps of:
identifying, by a processor, a plurality of electronic messages addressed to a user;
analyzing, by a large language model executed by the processor, the plurality of electronic messages to identify potential actions;
suggesting, by the processor, to the user, a potential action identified by the large language model;
receiving, by the processor, user input related to the potential action; and
performing, by the processor, on behalf of the user, a subsequent action conforming to the user input.

10. The non-transitory computer-readable storage medium of claim 9, wherein performing the subsequent action comprises performing the subsequent action via a large language model agent that interoperates with the large language model.

11. The non-transitory computer-readable storage medium of claim 9, wherein identifying the plurality of electronic messages comprises identifying a thread of messages about a same subject and analyzing messages within the thread in context with other messages within the thread.

12. The non-transitory computer-readable storage medium of claim 9, wherein receiving user input related to the potential action comprises receiving a modification of the potential action provided by the user via a chat interface and generating a new potential action using the large language model, wherein performing the subsequent action comprises performing the new potential action.

13. The non-transitory computer-readable storage medium of claim 9, wherein performing the subsequent action comprises creating a digital calendar event on behalf of the user.

14. The non-transitory computer-readable storage medium of claim 9, wherein performing the subsequent action comprises sending an electronic message on behalf of the user.

15. The non-transitory computer-readable storage medium of claim 9, wherein performing the subsequent action comprises sending input to an application programming interface.

16. The non-transitory computer-readable storage medium of claim 9, wherein suggesting the potential action to the user comprises generating, by the large language model, a description of the potential action and displaying the description in a user interface.

17. A device comprising:
a processor; and
a storage medium for tangibly storing thereon logic for execution by the processor, the logic comprising instructions for:
identifying, by the processor, a plurality of electronic messages addressed to a user;
analyzing, by a large language model executed by the processor, the plurality of electronic messages to identify potential actions;
suggesting, by the processor, to the user, a potential action identified by the large language model;
receiving, by the processor, user input related to the potential action; and
performing, by the processor, on behalf of the user, a subsequent action conforming to the user input.

18. The device of claim 17, wherein performing the subsequent action comprises performing the subsequent action via a large language model agent that interoperates with the large language model.

19. The device of claim 17, wherein identifying the plurality of electronic messages comprises identifying a thread of messages about a same subject and analyzing messages within the thread in context with other messages within the thread.

20. The device of claim 17, wherein receiving user input related to the potential action comprises receiving a modification of the potential action provided by the user via a chat interface and generating a new potential action using the large language model, wherein performing the subsequent action comprises performing the new potential action.
